(19) United States
(12) Patent Application Publication
(10) Pub. No.: US 2025/0114890 A1
(43) Pub. Date: Apr. 10, 2025

(54) METHOD FOR CARRYING OUT A DISPLACEMENT MOVEMENT AND A PNEUMATIC SYSTEM

(71) Applicant: Festo SE & Co. KG, Esslingen (DE)

(72) Inventors: Matthias DOLL, Wernau (DE); Rüdiger Neumann, Ostfildern (DE); David Rager, Nürtingen (DE); Michael FRÜH, Filderstadt (DE); Andreas Gause, Remshalden (DE)

(21) Appl. No.: 18/909,339

(22) Filed: Oct. 8, 2024

(30) Foreign Application Priority Data
Oct. 9, 2023 (DE) 102023127481.3

(51) Int. Cl. B23Q 3/155

(52) U.S. Cl. CPC B23Q 3/15526; B23Q 2003/1553; B23Q 2003/15537

(57) ABSTRACT

Methods and systems for carrying out a displacement movement of a drive element of a pneumatic drive unit. The method including by way of a first valve unit of a valve device, carrying out a pressure closed-loop control of a first pressure chamber of the pneumatic drive unit, in order to effect the displacement movement along a displacement path, by way of a second valve unit of the valve device, providing a throttle function for compressed air which given the displacement movement escapes from the second pressure chamber of the pneumatic drive unit, in order to influence the displacement movement, and in dependence on a position of the drive element and/or the time and/or a trigger signal, adapting a pressure setpoint of the pressure closed-loop control and a throttle opening of the throttle function during the displacement movement.

### CROSS-REFERENCE TO RELATED APPLICATIONS

This application claims the benefit of German application DE 102023127481.3, filed Oct. 9, 2023, which is incorporated herein by reference.

The invention relates to a method for carrying out a displacement movement of a drive element of a pneumatic drive unit.

The pneumatic drive unit is for example a pneumatic drive cylinder and the drive element for example is a piston. Conventionally, a displacement movement of a position of a pneumatic drive cylinder is effected by way of a first pressure chamber of the drive cylinder being subjected to the fully available supply pressure by way of a switching valve and the compressed air which escapes out of a second pressure chamber of the drive cylinder being throttled by way of an exhaust air throttle which is located on the drive cylinder. The exhaust air throttle serves for reducing a drive-side (thus originating from the first pressure chamber) excess of force. A high interference resistance of the drive can be achieved with this conventional approach, but at the same time the efficiency is reduced with regard to the compressed air consumption.

### SUMMARY

An object of the invention lies in permitting an execution of a displacement movement of the drive element which is efficient with regard to the consumed compressed air.

This object is achieved by a method according to the disclosure. The method comprise the steps: by way of a first valve unit of a valve device, carrying out a pressure closed-loop control of a first pressure chamber of the pneumatic drive unit, in order to effect the displacement movement along a displacement path, by way of a second valve unit of the valve device, providing a throttle function for compressed air which given the displacement movement escapes from a second pressure chamber of the pneumatic drive unit, in order to influence the displacement movement, and in dependence on a position of the drive element and/or the time and/or a trigger signal, adapting a pressure setpoint of the pressure closed-loop control and a throttle opening of the throttle function during the displacement movement.

Due to the fact that the pressure setpoint as well as the throttle opening are adapted during the displacement movement, it is possible for the displacement movement to be able to be carried out with less compressed air consumption and thus more efficiently. For example, the pressure setpoint can be reduced after an initial acceleration phase of the displacement movement, in order to avoid an unnecessarily high pressure being provided in the first pressure chamber for the displacement movement after this initial acceleration phase. Moreover, the throttle opening for example can be reduced towards the end of the displacement movement, in order to provide the braking effect which is necessary in particular for a gentle moving into an end position, not until this point in time. Since the throttle opening is not reduced until towards the end of the displacement movement, the braking effect is lower prior to this, so that a lower drive force and thus a lower pressure is required in the first pressure chamber for the displacement movement.

According to a preferred embodiment, the displacement path is subdivided into several successive displacement path zones. One or more zone parameters are assigned to each displacement path zone. The zone parameters comprise a pressure setpoint, a throttle opening value or a zone boundary value which defines a beginning and/or an end of the respective displacement path zone. The displacement movement can be adapted to a present application in a simple manner by way of a suitable choice of the zone parameters.

Expediently, no position closed-loop control is carried out for the displacement movement. In particular, no position closed-loop control of the drive element is carried out during the displacement movement. The pressure closed-loop control in particular is not effected in the course of a position closed-loop control.

Advantageous further developments are the subject-matter of the dependent claims.

The invention further relates to a pneumatic system comprising a valve device and a pneumatic drive unit. The pneumatic system is designed to carry out the method.

### BRIEF DESCRIPTION OF THE DRAWINGS

Further exemplary details as well as exemplary embodiments are explained hereinafter with reference to the figures. Herein are shown

FIG. 1 a schematic representation of a pneumatic system,

FIG. 2 a schematic representation of a valve device,

FIG. 3 a schematic representation of a pneumatic drive unit and two illustratory pictures which show an adaptation of a pressure setpoint and of a throttle opening value,

FIG. 4 an arrangement with a pneumatic system, a machine tool, tools and a machine tool changeover flap.

### DETAILED DESCRIPTION

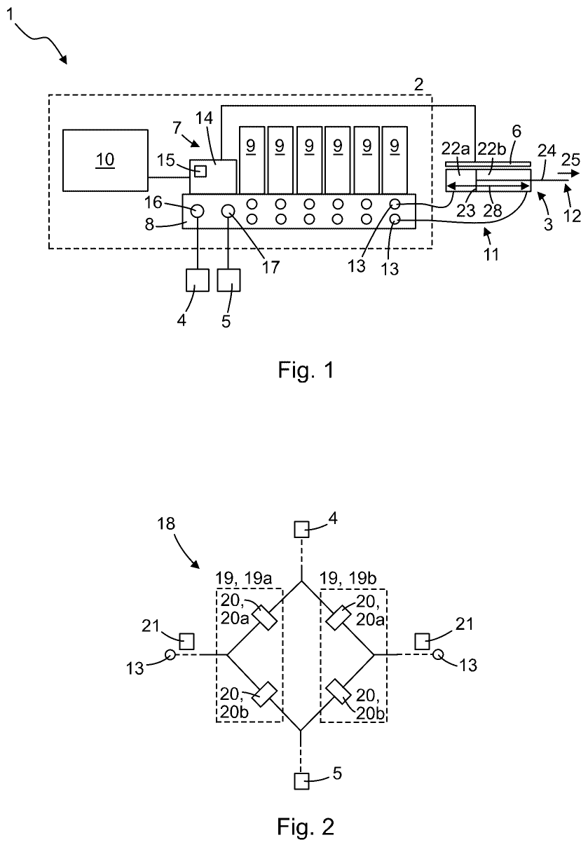

FIG. 1 shows an exemplary pneumatic system 1 which comprises a valve device 2 and a pneumatic drive unit 3. The valve device 2 serves for pneumatically actuating the pneumatic drive unit 2. In particular, the pneumatic system 1 is an industrial pneumatic system. The pneumatic system 1 is preferably applied in industrial automation.

Expediently, the pneumatic system 1 comprises a compressed air source 4, a compressed air sink 5, a position sensor device 6 and/or a hose arrangement 11. The compressed air source 4 is pneumatically connected to the valve device 2 and expediently provides the compressed air which is necessary for the pneumatic actuation of the pneumatic drive unit 3. The compressed air sink 5 is pneumatically connected to the valve device 2. Compressed air which given the pneumatic actuation of the drive unit 3 escapes from the pneumatic drive unit 3 is expediently exhausted into the compressed air sink 5 via the valve device 2. The compressed air sink 5 is for example the surroundings of the valve device 2.

The position sensor device 6 by way of example is arranged on the pneumatic drive unit 3 and expediently serves for detecting a position of the drive element 12 of the pneumatic drive unit 3. The position sensor device 6 can be designed as a part-path measurement system which expediently sensorically detects the position of the drive element 12 only in end positions regions of the drive unit 3. Between these end position regions, the position of the drive element 12 can be computed for example by a control device 10 and/or control unit 15 of the pneumatic system 1, in particular whilst using a detected pressure and/or a valve command signal, for example by way of computing a mass flow and/or whilst taking into account a throttle opening. Expediently, a position signal which relates to the position of the drive element 12 is provided on the basis of the sensorically detected position of the drive element 12 and/or the computed position of the drive element 12. The position signal is provided for example by the control device 10 and/or by the control unit 15. Furthermore, the position sensor device 6 can be designed as a full-path measurement system which sensorically detects the position of the drive element 12 in particular along the complete displacement path 28, so that the position signal is provided on the basis of the sensorically detected position.

The pneumatic drive unit 3 is pneumatically connected to the valve device 2 via the hose arrangement 11. By way of example, the hose arrangement 11 comprises a first hose with which a first pressure chamber 22a of the drive unit 3 is connected to the valve device 2, and a second hose with which a second pressure chamber 22b of the drive unit 3 is connected to the valve device 2.

The valve device 2 preferably comprises a valve arrangement 7 which by way of example is designed as a valve terminal. The valve arrangement 7 expediently comprises a carrier section 8 which in particular is designed in a plate-like manner, and a plurality of valve modules 9 which by way of example are arranged next to one another on the carrier section 8. According to an alternative design, the valve modules can be arranged in the carrier section 8. The valve arrangement 7 comprises a plurality of working connections 13 which by way of example are arranged on the carrier section 8. For the purpose of a better overview, only two of the working connections are provided with the reference numeral “13” in the figure. By way of example, the drive unit 3 is connected to two working connections 13. The valve device 2 can deliver compressed air to the drive unit 3 and can received compressed air which has escaped from the drive unit 3, via the two working connections 13.

By way of example, the valve arrangement 7 comprises a control section 14 which in particular is arranged on the carrier section 8. The control section 14 expediently comprises the control unit 15 which is designed for example as a microprocessor. The control section 14 by way of example is communicatively connected to the position sensor device 6. The valve arrangement 7 expediently comprises a (in particular arranged on the carrier section 8) compressed air inlet 16 (to which the compressed air source 4 is connected) and/or a (in particular arranged on the carrier section 8) compressed air outlet 17 (to which by way of example the compressed air sink 5 is connected).

By way of example, the valve arrangement 2 comprises a control device 10 which is expediently communicatively connected to the valve arrangement 7, in particular to the control unit 15. The control device 10 for example is a superordinate control device, in particular a programmable logic controller (PLC). Optionally, the control device 10 can be communicatively connected to the position sensor device 6.

The pneumatic drive unit 3 by way of example is designed as a pneumatic drive cylinder. The pneumatic drive unit 3 comprises the first pressure chamber 22a and the second pressure chamber 22b. The drive element 12 by way of example is designed as a piston arrangement and comprises a piston 23 and preferably a piston rod 24 which is attached to the piston 23. By way of example, the piston 23 separates the first pressure chamber 22a from the second pressure chamber 22b. The drive element 12 can be brought into a displacement movement, by way of example in a first displacement direction 25 due to the first pressure chamber 22 being pressurised and the second pressure chamber 22 being exhausted, by way of the valve arrangement 1.

FIG. 2 shows an exemplary design of a valve device 18. Expediently, the valve device 2 comprises at least one such valve device 18. By way of example, each of the valve modules 9 comprises a respective valve device 18. The valve device 18 comprises two valve units 19 and specifically a first valve unit 19a and a second valve unit 19b. Each valve unit 19 is connected to a respective working connection 13 and expediently serves for pneumatically connecting the respective working connection 13 to the compressed air source 4 or the compressed air sink 5, or optionally for blocking the respective working connection 13. Furthermore, each valve unit 19 expediently comprises a throttle function, in order to throttle the compressed air flow which is effected through the respective valve unit 19.

By way of example, the valve device 18 is designed as a pneumatic full bridge. The valve units 19 expediently form respective pneumatic half-bridges. By way of example, the valve device 19 comprises four valves, 20, in particular four 2/2-way valves, and/or each valve unit 19 comprises two valves 20, in particular two 2/2-way valves. The valves 20 in particular are designed as piezo-valves. By way of example, each valve unit 19 comprises a respective feed air valve 20a which is connected between the respectively associated working connection 13 and the compressed air source 4 and/or a respective exhaust air valve 20b which is connected between the respectively associated working connection 13 and the compressed air sink 5.

Alternatively, the valve arrangement can also be designed differently, in particular not as a full bridge. For example, the valve device (as the two valve units) can comprise respective 3/2-way valves or 3/3-way valves. Preferably, the valve device comprises separate control edges, in particular two working connections which can be pressurised and exhausted independently of one another.

The pneumatic system 1, in particular the valve device 2 comprises a pressure sensor device 21 which serves for detecting a compressed air pressure of the first chamber 22a and/or the second pressure chamber 22b. The pressure sensor device 21 for example can be part of the valve arrangement 7 and in particular can be arranged in the carrier section 8. In particular, the pressure sensor device 21 serves for detecting the compressed air pressures at the working connections 13.

The pneumatic system 1 is designed to carry out the subsequently described method for carrying out a displacement movement of the drive element 12. The displacement movement in particular is effected in a first displacement direction 25. The displacement movement is preferably effected from a first end position of the drive element 12 into a second end position of the drive element 12. What is meant by an end position is a position of the drive element 12 in which the drive element 12 cannot be moved further. In the second end position the drive element 12 cannot be moved further in the first displacement direction 25. In the first end position the drive element 12 cannot be moved further in the direction opposite to the first displacement direction 25.

The subsequently explained steps of the method in particular can be carried out simultaneously to one another. Expediently, all data processing which is carried out in the course of the method, thus in particular computations and/or adaptations of values are carried out by the control device 19 and/or the control unit 15.

The method comprises the step of carrying out a pressure closed-loop control 3 of the first pressure chamber 22a of the pneumatic drive unit 3 by way of the first valve unit 19a of the valve device 2, in order to effect a displacement movement along the displacement path 28. The closed-loop control of the pressure is expediently carried out by the control device 10 or by the control unit 15. The closed-loop control of the pressure in particular is effected by way of a pressure actual value of the first pressure chamber 22a being detected by way of the pressure sensor device 21 and (for example by the control unit 15 and/or the control device 10) being compared to a pressure setpoint and the first valve unit 19a being controlled (for example by the control unit 15 and/or the control device 10) on the basis of the comparison, in order to effect the changing of the actual value of the pressure towards the pressure setpoint. The displacement path 28 in particular is the complete stretch from the first end position of the drive element 12 to the second end position of the drive element 12. Expediently, the compressed air pressure in the first pressure chamber 22a is increased by the closed-loop control of the pressure such that by way of this a pneumatic force is exerted upon the piston 23, which has the effect of the drive element 12 carrying out the displacement movement.

The method comprises the further step of providing the throttle function for the compressed air by way of the second valve unit 19b of the valve device 2, said compressed air escaping from the second pressure chamber 22b of the pneumatic drive unit 3 given the displacement movement. The provision of the throttle function serves for influencing the displacement movement. Given the displacement movement, the compressed air flows from the second pressure chamber 22b via the second valve unit 19b into the compressed air sink 5, for example the surroundings of the valve device 2. The compressed air in particular escapes from the second pressure chamber 22b due to the fact that the compressed air pressure in the second pressure chamber 22b is greater than the pressure of the surroundings, in particular on account of the second pressure chamber 22b becoming smaller due to the displacement movement of the drive element 12. A throttle opening-thus in particular a size of the through-flow cross section—can be set on the pneumatic path of the compressed air which escapes the second pressure chamber 22b, by way of the throttle function, in order by way of this to set the amount of throttling of the throughflow of the compressed air. For example, the throttle opening can be set by the positioning of a valve element of the exhaust air valve 20b.

The method further comprises the step of adapting the pressure setpoint of the closed-loop control of the pressure and the throttle opening of the throttle function during the displacement movement in dependence on a position of the drive element and/or the time and/or a triggers signal, for example by the control unit 15 and/or by the control device 10. The further closed-loop control of the pressure (being effected for the displacement movement) is then carried out on the basis of the adapted pressure setpoint and the further (being effected for the displacement movement) throttle function is then carried out on the basis of the adapted throttle opening. The throttle opening to be used is set for example by way of a throttle opening value, in particular by the control device 10 and/or the control unit 15.

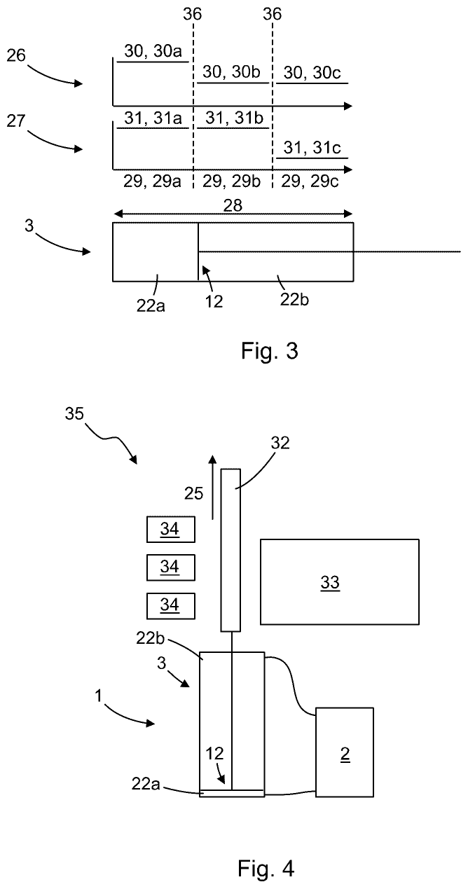

As to how the adaption of the pressure setpoint and the throttle opening can be effected by way of example is dealt with in more detail hereinafter with reference to FIG. 3.

FIG. 3 shows the drive unit 3, a first illustratory picture 26 which shows an adaption of the pressure setpoint, and a second illustratory picture 27 which shows an adaption of the throttle opening.

The displacement path 28 is preferably divided into several successive displacement path zones 29. The subdivision is shown in FIG. 3 by way of dashed vertical lines which are to represent zone boundaries 36.

By way of example, the displacement path 28 is subdivided into three, in particular into only three successive displacement path zones 29: a first displacement path zone 29a, a second displacement path zone 29b and a third displacement path zone 29c. By way of example, given the displacement movement, the drive element 12 firstly moves through the first displacement path zone 29a in the displacement direction 25, then through the second displacement path zone 29b and then through the third displacement path zone 29c. The subdivision of the displacement path 28 is expediently defined in the control device 10 and/or in the control unit 15.

Alternatively, the displacement path 28 can also be divided into only two displacement path zones 29 or into more than three displacement path zones.

The subdivision of the displacement path zones 29 is expediently defined via the zone boundaries 36. The zone boundaries 36 are expediently stored by way of corresponding zone boundary values, for example in the control device 10 and/or the control unit 15. The zone boundaries 36 are expediently defined as positions along the displacement path 28; for example each zone boundary 36 is stored as a respective position value. The zone boundaries 36 can be defined at the same time and accordingly stored as time values. The time values relate for example to time durations which start from the beginning of the displacement movement. Moreover, the zone boundaries 36 can be defined in an event-based manner. For example, one or more zone boundaries 26 are specified on the basis of a trigger signal, in particular in a manner such that for the displacement path zone 29 in which the drive element is currently located, a zone boundary 36 which defines the end of the displacement path zone 29 is drawn as a response to a trigger signal being present.

The adaption of the pressure setpoint is preferably effected as a response to the drive element 12 moving from one of the displacement path zones 29 into a subsequent displacement path zone 29 given the displacement movement. Expediently, the adaption of the throttle opening is effected as a response to the drive element 12 moving from one of the displacement path zones 29 into a subsequent displacement path zone 29 given the displacement movement. For example, the control device 10 and/or the control unit 15 (in particular one the basis of the position signal, thus preferably on the basis of a position of the drive element 12 which is detected by the position sensor device 6 and/or computed) detects that the drive element 12 has moved from one displacement path zone 29 into the next displacement path zone 29 and as a response to this adapts the pressure setpoint and/or the throttle opening value.

As mentioned above, a measuring system for the complete displacement path 28 or a part path measurement system (e.g. in the end positions) can be used for the position signal. Preferably, the position signal can be provided on the basis of an estimated position. The estimation of the position is effected e.g. on the basis of pressure signals and valve positions or the volume flow signal. For example, the estimation of the position is carried out for a middle region of the displacement path 28 and the position is sensorically detected in the end positions. Expediently, a continuous feedback of the position of the drive element 12 is not affected. For example, the position detection is only effected at individual points along the displacement path 28, in order on the basis of this to determine a transition from one displacement path zone 29 to the next displacement path zone 29. The position of the drive element 12 can be detected at the end positions, for example by way of end position switches.

Preferably, one or more zone parameters are assigned to each displacement path zone 28. The zone parameters comprise for example a pressure setpoint 30 and/or a throttle opening value 31. Optionally, the zone parameters comprise a zone boundary value which defines a beginning and/or an end of the respective displacement path zone 29. For example, each zone boundary value defines a position of the drive element 12 at which the respective displacement path zone begins and/or a position of the drive element 12 at which the respective displacement path zone ends. Moreover, each zone boundary value can define a time value.

Preferably, a respective pressure setpoint 30 for the closed-loop control of the pressure and a respective throttle opening value 31 for the throttle opening is assigned to each displacement path zone 29. The pressure setpoints 30 and the throttle opening values 31 are represented as horizontal lines in the illustratory pictures of FIG. 3. By way of example, a first pressure setpoint 30a and a first throttle opening value 31a are assigned to the first displacement path zone 29a, a second pressure setpoint 30b and a second throttle opening value 31b are assigned to the second displacement path zone 29b and a third pressure setpoint 30c and a third throttle opening value 31c are assigned to the third displacement path zone 29c.

Expediently, the closed-loop control of the pressure is effected in each displacement path zone 29 on the basis of the respectively assigned pressure setpoint 30. The throttle function is expediently provided in each displacement path zone 29 according to the respectively assigned throttle opening value 31. Preferably, at least two of the pressure setpoints 30 differ from one another and/or at least two of the throttle opening values 31 differ from one another.

Preferably, the pressure setpoint 30 is reduced as a response to the drive element 12 leaving a displacement path zone 29 which is situated in a front region of the displacement path 28. Preferably, the pressure setpoint 30 is reduced as a response to the drive element leaving the displacement path zone 29a which is first in the displacement direction 25. What is meant by the term “the displacement path zone 29a which is first in the displacement direction of the displacement movement” is that displacement path zone which is firstly passed through given the displacement movement in the displacement direction. The second pressure setpoint 30b is expediently smaller than the first pressure setpoint 30a. This reduction of the pressure setpoint 30 in particular is effected after an initial acceleration phase of the displacement movement, in order to avoid an unnecessarily high pressure being provided in the first pressure chamber 22a for the displacement movement after this initial acceleration phase.

Preferably, the throttle opening is constant given the transition from the displacement path zone 29a which is first in the displacement direction 25 of the displacement movement to the second displacement path zone 29b. The second throttle opening value 31b by way of example is equal to the first throttle opening value 31a.

Preferably, the throttle opening is reduced as a response to the drive element entering into a displacement path zone 29 which is situated in a rear region of the displacement path. For example, the throttle opening is reduced as a response to the drive element 12 entering into the displacement path zone 29c which is third in the displacement direction 25 of the displacement movement. The third throttle opening value 31c is expediently smaller than the second throttle opening value 31b. A braking effect can be achieved by way of the reduction of the throttle opening.

The pressure setpoint 30 preferably remains constant given the transition from the displacement path zone 29b which is second in the displacement direction 25 of the displacement movement to the third displacement path zone 29c.

Optionally, the zone parameters can comprise a blocking state parameter, for example a blocking state flag. The blocking state parameter expediently indicates a blocking state of the first pressure chamber 22a for the respective displacement path zone. In the blocking state, the first pressure chamber 22a is blocked by way of the first valve unit 19a, so that a feeding or leading-away of compressed air into and out of the first pressure chamber 22a is not possible. Expediently, when the blocking state parameter is set for a displacement path zone 29, then the pressure closed-loop control is skipped for this displacement path zone 29 and the first pressure chamber 22a is closed whilst the drive element 12 is located in this displacement path zone 29. For example, the blocking state parameter is set for the second displacement path zone 29b and/or the third displacement path zone 29c.

Optionally, after completion of the displacement movement—thus in particular when the drive element 12 is located in the second end position—a pressure closed-loop control of the first pressure chamber 22a and/or of the second pressure chamber 22b is effected, in particular in a manner such that a force which is directed in the direction of the second end position is produced, said force expediently holding the drive element 12 in the second end position.

The manner in which the zone parameters can be defined is dealt with in more detail hereinafter.

Optionally, the zone parameters can be inputted by the user, for example by way of a user appliance and/or an input device of the valve arrangement.

The zone parameters can be determined for example on the basis of a simulation and/or optimisation procedure. Optionally, the zone parameters can be determined by way of machine-learning.

Preferably, one or more of the zone parameters are adapted on the basis of the position signal which relates to a position of the drive element 12. The adaption is preferably effected in an automatic manner, in particular by way of the control device 10 and/or the control unit 15. For example, the adaption is effected in the basis of a comparison of a recorded trajectory (this of a path-time diagram) of the drive element 12 with a desired trajectory. Expediently, the adaptation is assisted by model, in particular by way of an adaption routine.

Preferably, a displacement path characteristic is detected, in particular on the basis of the position signal. The displacement path characteristic for example includes an oscillation of the drive element, a rebounding of the drive element, a displacement duration of the displacement movement and/or a premature standstill of the drive element 12. The rebound of the drive element 12 means e.g. that the drive element 12 moves into the second end position with too high a speed and therefore bounces back—thus moves out of the second end position in a direction opposite to the displacement movement 25. The premature standstill means e.g. that the drive element 12 comes to a standstill during the displacement movement before it reaches the second end position. Preferably, one or more of the zone parameters are adapted on the basis of the displacement path characteristic, in particular in a manner so as to avoid or reduce an undesirable displacement path characteristic.

Preferably, one or more of the zone parameters are adapted by way of an optimisation algorithm, in order to optimise a quality criterion. For example, the optimisation of the quality criterion includes a minimising of a trajectory error of the drive element 12 and/or a minimising of an end value error of the drive element 12. The end value error in particular includes a displacement duration error, an end position speed error and/or an end position pressure error.

The trajectory error is for example a deviation of a recorded trajectory of the drive element 12 from such a desired trajectory. For example, the trajectory error is computed as the sum of the square deviation of the recorded trajectory from the desired trajectory.

The displacement duration error in particular is a deviation of a detected displacement duration which the drive element 12 requires for the displacement movement, from a desired displacement duration.

The end position speed error in particular is a deviation of a detected end position speed at which the drive element 12 moves into the second end position, from a desired end position speed.

The end position pressure error in particular is a deviation of the detected end position pressure which prevails in the first pressure chamber 22a or the second pressure chamber 22b when the drive element 12 is situated in the second end position, from a desired end position pressure.

The optimisation algorithm is preferably model-based and/or uses machine learning, e.g. reinforcement learning.

The adaption of the zone parameters is preferably effected after completion of the displacement movement. For example, the end value error is demined after completion of the displacement movement and the zone parameters adapted on the basis of the end position error, in order to reduce the end position error given the next displacement movement. The next displacement movement take space amid the use of the adapted zone parameters.

Optionally, one or more of the zone parameters are adapted during the displacement movement. The pressure closed-loop control and/or the throttle function for this displacement movement are preferably carried out after the adaption according to the one or more adapted zone parameters. In this manner, a disturbance can be compensated for in a direct manner during the displacement movement. For this, a model predictive control (MPC) is preferably applied. Alternately, a reinforcement learning approach can be applied

An arrangement 35 which represents an exemplary application environment for the pneumatic system 1 is discussed with reference to FIG. 4. The arrangement 35 comprises the pneumatic system 1, a machine tool 33, tools 34 for the machine tool, and a tool changeover flap 32.

The drive element 12 in particular serves for actuating the tool changeover flap 32. In particular, the tool changeover flap can be brought from a first position, for example a closure position, into a second position, for example an open position, by way of the displacement movement of the drive element 12. In the closure position, the tool changeover flap 32 separates the tools 34 from the machine tool 33, in particular for the purpose of not contaminating the tools 34 given a machining procedure which is carried out by the machine tool 33. In the open position, the tool changeover flap 32 releases an access to the tools 34, so that one of the tools 34 can be transported to the machine tool 33 (in particular for the purpose of a tool exchange), for example by a (not shown) tool handling device, for example a robot arm.

A rapid opening and/or closing of the tool changeover flap 32 with a low consumption of compressed air can be achieved by way of the adaption of the pressure setpoint 30 and the throttle opening, which is described above.

1. A method for carrying out a displacement movement of a drive element of a pneumatic drive unit, comprising the steps:
by way of a first valve unit of a valve device, carrying out a pressure closed-loop control of a first pressure chamber of the pneumatic drive unit, in order to effect the displacement movement along a displacement path,
by way of a second valve unit of the valve device, providing a throttle function for compressed air which given the displacement movement escapes from the second pressure chamber of the pneumatic drive unit, in order to influence the displacement movement, and
in dependence on a position of the drive element and/or the time and/or a trigger signal, adapting a pressure setpoint of the pressure closed-loop control and a throttle opening of the throttle function during the displacement movement.

2. The method according to claim 1, wherein the displacement path is subdivided into several successive displacement path zones, wherein the adaption of the pressure setpoint is effected as a response to the drive element, given the displacement movement, moving from one of the displacement path zones into a subsequent displacement path zone and wherein the adapting of the throttle opening is effected as a response to the drive element, given the displacement movement, moving from one of the displacement path zones into a subsequent displacement path zone.

3. The method according to claim 2, wherein a respective pressure setpoint for the pressure closed-loop control and a respective throttle opening value for the throttle opening are assigned to each displacement path zone, wherein the pressure closed-loop control in each displacement path zone is effected on the basis of the respectively assigned setpoint and the throttle function in each displacement path zone is provided according to the respectively assigned throttle opening value, wherein at least two of the pressure setpoints differ from one another and/or wherein at least two of the throttle opening values differ from one another.

4. The method according to claim 2, wherein the pressure setpoint is reduced as a response to the drive element leaving a displacement path zone which is situated in a front region of the displacement path.

5. The method according to claim 2, wherein the throttle opening is reduced as a response to the drive element entering into a displacement path zone which is situated in a rear region of the displacement path.

6. The method according to claim 2, wherein the displacement path is subdivided into three successive displacement path zones.

7. The method according to claim 6, wherein the pressure setpoint is reduced as a response to the drive element leaving the displacement path zone which is first in the direction of the displacement movement.

8. The method according to claim 6, wherein the throttle opening is reduced as a response to the drive element entering into the displacement path zone which is third in the displacement direction of the displacement movement.

9. The method according to claim 6, wherein the pressure setpoint remains constant given the transition from the displacement path zone which is second in the displacement direction of the displacement movement to the third displacement path zone and/or the throttle opening remains constant given the transition from the displacement path zone which is first in the displacement direction of the displacement movement to the second displacement path zone.

10. The method according to claim 2, wherein one or more zone parameters are assigned to each displacement path zone, wherein the zone parameters include a pressure setpoint, a throttle opening value or a zone boundary value which defines a beginning and/or an end of the respective displacement path zone.

11. The method according to claim 10, wherein one or more of the zone parameters is adapted on the basis of a position sensor signal which relates to a position of the drive element.

12. The method according to claim 10, wherein one or more of the zone parameters is adapted during the displacement movement and the pressure closed-loop control and/or the throttle function for this displacement movement is carried out after the adaptation according to the one or more adapted zone parameters.

13. The method according to claim 10, wherein at least one displacement path characteristic is detected, said displacement path characteristic comprising an oscillation of the drive element, a rebounding of the drive element, a displacement duration of the displacement movement and/or a premature standstill of the drive element and wherein one or more of the zone parameters are adapted on the basis of the displacement path characteristic.

14. The method according to claim 10, wherein one or more of the zone parameters is adapted by way of an optimisation algorithm, in order to optimise a quality criterion.

15. The method according to claim 14, wherein the optimisation of the quality criterion includes a minimising of a trajectory error of the drive element and/or a minimising of an end value error of the drive element, wherein the end value error comprises a displacement duration error, an end position speed error and/or an end position pressure error.

16. The method according to claim 1, wherein a tool changeover flap is actuated by the drive element, said tool changeover flap separating a machine tool from one or more tools for the machine tool.

17. A pneumatic system comprising a valve device and a pneumatic drive unit, wherein the pneumatic system is designed to carry out a method according to claim 1.
